(19) United States
(12) Patent Application Publication
(10) Pub. No.: US 2024/0289197 A1
(43) Pub. Date: Aug. 29, 2024

(54) LEADING ERROR REPORTING FOR DATA STORAGE APPARATUS

(71) Applicant: International Business Machines Corporation, Armonk, NY (US)

(72) Inventors: Hiroshi Itagaki, Yokohama-shi (JP); Tohru Hasegawa, Tokyo (JP); Atsushi Abe, Ebina (JP); Tsuyoshi Miyamura, Yokohama-shi (JP); Noriko Yamamoto, Tokyo (JP); Shinsuke Mitsuma, Machida-shi (JP)

(21) Appl. No.: 18/114,911

(22) Filed: Feb. 27, 2023

(51) Int. Cl. G06F 11/07

(52) U.S. Cl. CPC G06F 11/0769; G06F 11/0793

(57) ABSTRACT

In one general embodiment, a method includes receiving, at a data storage device that performs data operations on magnetic media, a command indicating a read range of records to read. A determination is made as to whether one or more of the records within the read range is expected to cause an error. In response to determining that one or more of the records within the read range is known to cause an error, an indication indicative of the record known to cause the error is returned.

### BACKGROUND

The present invention relates to data storage systems, and more particularly, this invention relates to error reporting.

In magnetic storage systems, magnetic transducers read data from and write data onto magnetic recording media. Data is written on the magnetic recording media by moving a magnetic recording transducer to a position over the media where the data is to be stored. The magnetic recording transducer then generates a magnetic field, which encodes the data into the magnetic media. Data is read from the media by similarly positioning the magnetic read transducer and then sensing the magnetic field of the magnetic media. Read and write operations may be independently synchronized with the movement of the media to ensure that the data can be read from and written to the desired location on the media.

An important and continuing goal in the data storage industry is that of increasing the density of data stored on a medium. For tape storage systems, that goal has led to increasing the track and linear bit density on recording tape, and decreasing the thickness of the magnetic tape medium. However, the development of small footprint, higher performance tape drive systems has created various challenges ranging from the design of tape head assemblies for use in such systems to dealing with tape dimensional instability.

### SUMMARY

A method, in accordance with one embodiment, includes receiving, at a data storage device that performs data operations on magnetic media, a command indicating a read range of records to read. A determination is made as to whether one or more of the records within the read range is expected to cause an error. In response to determining that one or more of the records within the read range is known to cause an error, an indication indicative of the record known to cause the error is returned.

A method, in accordance with one embodiment, includes receiving, at a data storage device that performs data operations on magnetic media, a read command indicating target records to read. A determination is made as to whether a read range is set. In response to determining that no read range is set, a normal read operation is performed for returning the target records indicated in the read command. In response to determine that a read range is set, a number of records to read ahead based on the read range. The target records requested by the read command are read and a read ahead operation of additional records is performed according to the number of records to read ahead. In response to determining that one of the additional records read during the read ahead operation has an error, a flag indicative of the target record causing the error is set. A determination is made as to whether a leading error flag is set. An indication indicative of the record that caused the error during the read ahead operation is sent according to the leading error flag.

A method, in accordance with one embodiment, includes obtaining, from an index file, a range of records in which a target record is located. A command to set a read range is sent. Also, a read command to read the target record is sent. The target record is received, as well as an indication indicative of a record within the read range that caused an error during a read ahead operation of records within the read range.

An apparatus, in accordance with various embodiments, includes a magnetic head, and a controller coupled to the magnetic head, the controller being configured to perform any the foregoing methods.

A computer program product, in accordance with various embodiments, includes one or more computer readable storage media, and program instructions collectively stored on the one or more computer readable storage media, the program instructions include program instructions to perform any of the foregoing methods.

Any of these embodiments may be implemented in a magnetic data storage system such as a tape drive system, which may include a magnetic head, a drive mechanism for passing a magnetic medium (e.g., recording tape) over the magnetic head, and a controller electrically coupled to the magnetic head.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a schematic diagram of a simplified tape drive system, in accordance with one embodiment.

FIG. 2B is a schematic diagram of a tape cartridge, in accordance with one embodiment.

FIG. 2C illustrates a side view of a flat-lapped, bi-directional, two-module magnetic tape head, in accordance with one embodiment.

FIG. 2D is a tape bearing surface view taken from Line 2D of FIG. 2C.

FIG. 2E is a detailed view taken from Circle 2E of FIG. 2D.

FIG. 2F is a detailed view of a partial tape bearing surface of a pair of modules.

FIG. 3 is a partial tape bearing surface view of a magnetic tape head having a write-read-write configuration, in accordance with one embodiment.

FIG. 4 is a partial tape bearing surface view of a magnetic tape head having a read-write-read configuration, in accordance with one embodiment.

FIG. 5 is a side view of a magnetic tape head with three modules where the modules all generally lie along about parallel planes, in accordance with one embodiment.

FIG. 6 is a side view of a magnetic tape head with three modules in a tangent (angled) configuration, in accordance with one embodiment.

FIG. 7 is a side view of a magnetic tape head with three modules in an overwrap configuration.

FIGS. 8A-8C are schematics depicting the principles of tape tenting.

FIG. 9 is a representational diagram of files and indexes stored on a magnetic tape, in accordance with one embodiment.

FIG. 10 graphically represents a tape drive encountering a failure while performing read ahead.

FIG. 11 graphically represents reporting of the error encountered in FIG. 10.

FIG. 12 is a flowchart of a method for processing a SetReadRange command, in accordance with one embodiment.

FIG. 13 is a flowchart of a method for processing a Read command, in accordance with one embodiment.

FIG. 14 is a flowchart of a method for reading data, in accordance with one embodiment.

FIG. 15 is a flowchart of a method performed by a requestor of a target record, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of magnetic storage systems, as well as operation and/or component parts thereof.

In one general embodiment, a method includes receiving, at a data storage device that performs data operations on magnetic media, a command indicating a read range of records to read. A determination is made as to whether one or more of the records within the read range is expected to cause an error. In response to determining that one or more of the records within the read range is known to cause an error, an indication indicative of the record known to cause the error is returned.

In another general embodiment, a method includes receiving, at a data storage device that performs data operations on magnetic media, a read command indicating target records to read. A determination is made as to whether a read range is set. In response to determining that no read range is set, a normal read operation is performed for returning the target records indicated in the read command. In response to determine that a read range is set, a number of records to read ahead based on the read range. The target records requested by the read command are read and a read ahead operation of additional records is performed according to the number of records to read ahead. In response to determining that one of the additional records read during the read ahead operation has an error, a flag indicative of the target record causing the error is set. A determination is made as to whether a leading error flag is set. An indication indicative of the record that caused the error during the read ahead operation is sent according to the leading error flag.

In another general embodiment, a method includes obtaining, from an index file, a range of records in which a target record is located. A command to set a read range is sent. Also, a read command to read the target record is sent. The target record is received, as well as an indication indicative of a record within the read range that caused an error during a read ahead operation of records within the read range.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for leading error reporting in block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

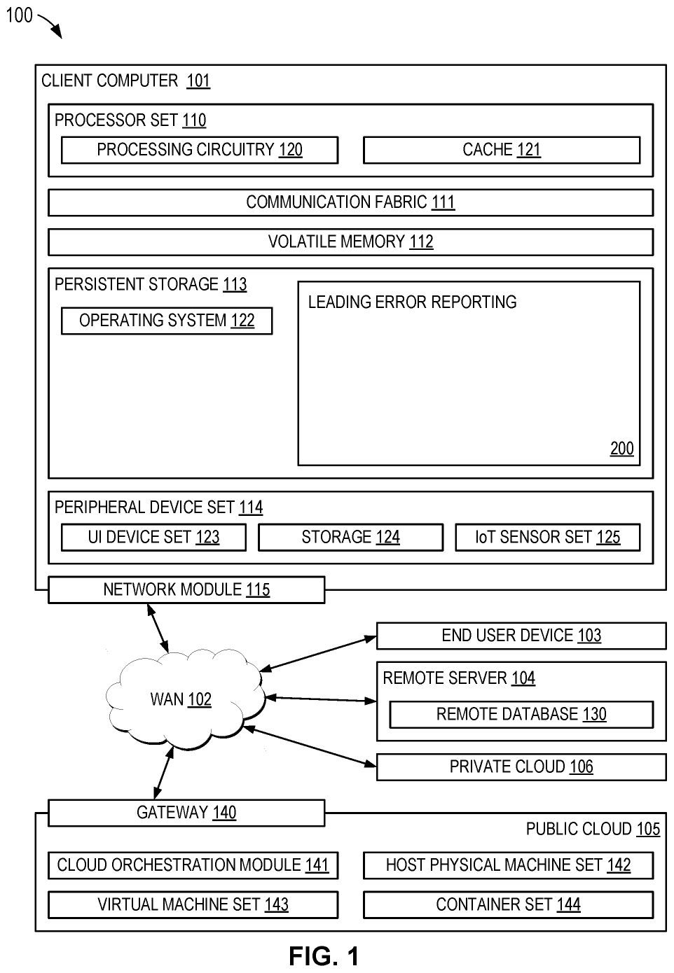

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

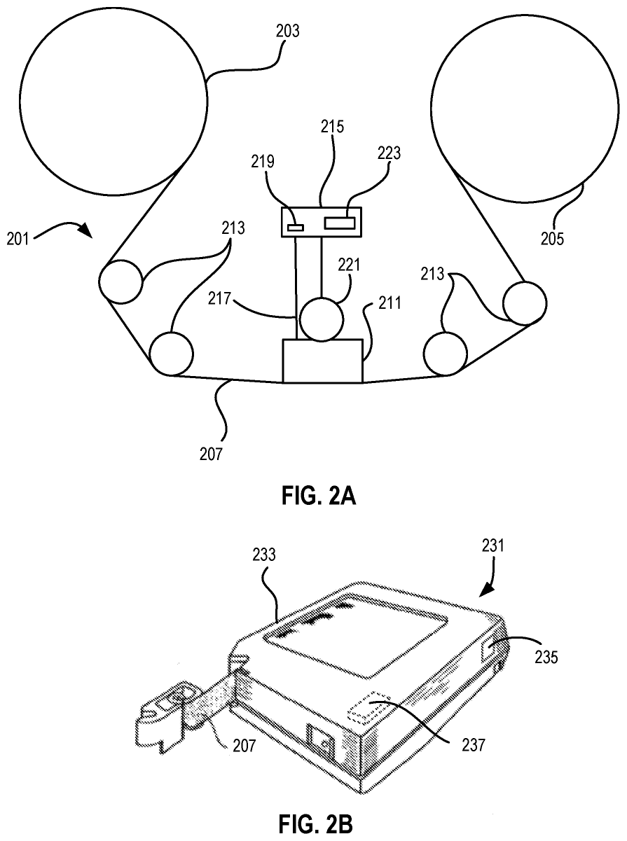

FIG. 2A illustrates a simplified tape drive 201 of a tape-based data storage system, which may be employed in the context of the present invention. While one specific implementation of a tape drive is shown in FIG. 2A, it should be noted that the embodiments described herein may be implemented in the context of any type of tape drive system.

As shown, a tape supply cartridge 203 and a take-up reel 205 are provided to support a tape 207. One or more of the reels may form part of a removable cartridge and are not necessarily part of the tape drive 201. The tape drive, such as that illustrated in FIG. 2A, may further include drive motor(s) to drive the tape supply cartridge 203 and the take-up reel 205 to move the tape 207 over a tape head 211 of any type. Such head may include an array of read transducers (also referred to as readers), write transducers (also known in the art as writers), or both.

Guides 213 guide the tape 207 across the tape head 211. Such tape head 211 is in turn coupled to a controller 215 via a cable 217. The controller 215, may be or include a processor and/or any logic for controlling any subsystem of the drive 201. For example, the controller 215 typically controls head functions such as servo following, data writing, data reading, etc. The controller 215 may include at least one servo channel and at least one data channel, each of which include data flow processing logic configured to process and/or store information to be written to and/or read from the tape 207. The controller 215 may operate under logic known in the art, as well as any logic disclosed herein, and thus may be considered as a processor for any of the descriptions of tape drives included herein, in various embodiments. The controller 215 may be coupled to a memory 219 of any known type, which may store instructions executable by the controller 215. Moreover, the controller 215 may be configured and/or programmable to perform or control some or all of the methodology presented herein. Thus, the controller 215 may be considered to be configured to perform various operations by way of logic programmed into one or more chips, modules, and/or blocks; software, firmware, and/or other instructions being available to one or more processors; etc., and combinations thereof.

The cable 217 may include read/write circuits to transmit data to the tape head 211 to be recorded on the tape 207 and to receive data read by the tape head 211 from the tape 207. An actuator 221 controls position of the tape head 211 relative to the tape 207.

An interface 223 may also be provided for communication between the tape drive 201 and a host (internal or external) to send and receive the data and for controlling the operation of the tape drive 201 and communicating the status of the tape drive 201 to the host, all as will be understood by those of skill in the art.

FIG. 2B illustrates an exemplary tape cartridge 231 according to one embodiment. Such tape cartridge 231 may be used with a system such as that shown in FIG. 2A. As shown, the tape cartridge 231 includes a housing 233, a tape 207 in the housing 233, and a nonvolatile memory 237 coupled to the housing 233. In some approaches, the nonvolatile memory 237 may be embedded inside the housing 233, as shown in FIG. 2B. In more approaches, the nonvolatile memory 237 may be attached to the inside or outside of the housing 233 without modification of the housing 233. For example, the nonvolatile memory may be embedded in a self-adhesive label 235. In one preferred embodiment, the nonvolatile memory 237 may be a Flash memory device, read-only memory (ROM) device, etc., embedded into or coupled to the inside or outside of the tape cartridge 231. The nonvolatile memory is accessible by the tape drive and the tape operating software (the driver software), and/or another device.

By way of example, FIG. 2C illustrates a side view of a flat-lapped, bi-directional, two-module magnetic tape head 211 which may be implemented in the context of the present invention. As shown, the head includes a pair of bases 202, each equipped with a module 204, and fixed at a small angle α with respect to each other. The bases may be “U-beams” that are adhesively coupled together. Each module 204 includes a substrate 204A and a closure 204B with a thin film portion, commonly referred to as a “gap” in which the read transducers and/or write transducers 206 are formed. In use, a tape 208 is moved over the modules 204 along a media (tape) bearing surface 209 in the manner shown for reading and writing data on the tape 208 using the read transducers and write transducers. The wrap angle θ of the tape 208 at edges going onto and exiting the flat media support surfaces 209 are usually between about 0.1 degree and about 3 degrees.

The substrates 204A are typically constructed of a wear resistant material, such as a ceramic. The closures 204B may be made of the same or similar ceramic as the substrates 204A.

Cables 217 are provided for enabling communication between the controller and the transducers 206 of each of the modules 204. Pads on a cable 217 are typically wire bonded to pads on the associated module 204.

The read transducers and write transducers may be arranged in a piggyback or merged configuration. An illustrative piggybacked configuration comprises a (magnetically inductive) write transducer on top of (or below) a (magnetically shielded) read transducer (e.g., a magnetoresistive reader, etc.), wherein the poles of the write transducer and the shields of the read transducer are generally separated. An illustrative merged configuration comprises one reader shield in the same physical layer as one writer pole (hence, “merged”). The read transducers and write transducers may also be arranged in an interleaved configuration. Alternatively, each array of channels may be read transducers or write transducers only. Any of these arrays may contain one or more servo readers for reading servo data on the medium.

FIG. 2D illustrates the tape bearing surface 209 of one of the modules 204 taken from Line 2D of FIG. 2C. A representative tape 208 is shown in dashed lines. The module 204 is preferably long enough to be able to support the tape as the head steps between data bands.

In this example, the tape 208 includes 4 to 32 data bands, e.g., with 16 data bands and 17 servo tracks 210, as shown in FIG. 2D on a one-half inch wide tape 208. The data bands are defined between servo tracks 210. Each data band may include a number of data tracks, for example 1024 data tracks (not shown). During read/write operations, the read transducers and/or write transducers 206 are positioned to specific track positions within one of the data bands. Outer readers, sometimes called servo readers, read the servo tracks 210. The servo signals are in turn used in a conventional manner to keep the read transducers and/or write transducers 206 aligned with a particular set of tracks during the read/write operations.

FIG. 2E depicts a plurality of read transducers and/or write transducers 206 formed in a gap 218 on the module 204 in Circle 2E of FIG. 2D. As shown in FIG. 2E, the array of read transducers and write transducers 206 includes, for example, 16 write transducers 214, 16 read transducers 216 and two servo readers 212, though the number of elements may vary. Illustrative embodiments include 8, 16, 32, 40, and 64 active read transducers and/or write transducers 206 per array, and alternatively interleaved designs having odd numbers of read transducers or write transducers such as 17, 25, 33, etc. An illustrative embodiment includes 32 read transducers per array and/or 32 write transducers per array, where the actual number of transducer elements could be greater, e.g., 33, 34, etc. Multiple simultaneously-operated transducers allow the tape to travel at a modest velocity while maintaining a high data transfer rate. Lower velocities are desirable to reduce mechanical difficulties from speed-induced tracking.

While the read transducers and write transducers may be arranged in a piggyback configuration as shown in FIG. 2E, the read transducers 216 and write transducers 214 may also be arranged in an interleaved configuration. Alternatively, each array of read transducers and/or write transducers 206 may be read transducers or write transducers only, and the arrays may contain one or more servo readers 212. As noted by considering FIGS. 2C and 2D-2E together, each module 204 may include a complementary set of read transducers and/or write transducers 206 for such things as bi-directional reading and writing, read-while-write capability, backward compatibility, etc.

FIG. 2F shows a partial tape bearing surface view of complementary modules of a magnetic tape head 211 according to one embodiment. In this embodiment, each module has a plurality of read/write (R/W) pairs in a piggyback configuration formed on a common substrate 204A and an optional electrically insulative insulating layer 236. The write transducers 214 and the read transducers 216 are aligned parallel to an intended direction of travel of a tape medium thereacross to form an R/W pair, exemplified by R/W pairs 222. Note that the intended direction of tape travel is sometimes referred to herein as the direction of tape travel, and such terms may be used interchangeably. Such direction of tape travel may be inferred from the design of the system, e.g., by examining the guides; observing the actual direction of tape travel relative to the reference point; etc. Moreover, in a system operable for bi-direction reading and/or writing, the direction of tape travel in both directions is typically parallel and thus both directions may be considered equivalent to each other.

Several R/W pairs 222 may be present, such as 8, 16, 32 pairs, etc. The R/W pairs 222 as shown are linearly aligned in a direction generally perpendicular to a direction of tape travel thereacross. However, the pairs may also be aligned diagonally, etc. Servo readers 212 are positioned on the outside of the array of R/W pairs, the function of which is well known.

Generally, the magnetic tape medium moves in either a forward or reverse direction as indicated by arrow 220. The magnetic tape medium and head assembly 211 operate in a transducing relationship in the manner well-known in the art. The head assembly 211 includes two thin-film modules 224 and 226 of generally identical construction.

Modules 224 and 226 are joined together with a space present between closures 204B thereof (partially shown) to form a single physical unit to provide read-while-write capability by activating the write transducer of the leading module and read transducer of the trailing module aligned with the write transducer of the leading module parallel to the direction of tape travel relative thereto. When a module 224, 226 of a magnetic tape head 211 is constructed, layers are formed in the gap 218 created above an electrically conductive substrate 204A (partially shown), e.g., of AlTiC, in generally the following order for the R/W pairs 222: an insulating layer 236, a first shield 232 typically of an iron alloy such as NiFe (e.g., −80/20 at % NiFe, also known as permalloy), cobalt zirconium tantalum (CZT) or Al—Fe—Si (Sendust), a sensor 234 for sensing a data track on a magnetic medium, a second shield 238 typically of a nickel-iron alloy (e.g., permalloy), first and second writer poles 228, 230, and a coil (not shown). The sensor may be of any known type, including those based on magnetoresistive (MR), GMR, AMR, tunneling magnetoresistance (TMR), etc.

The first and second writer poles 228, 230 may be fabricated from high magnetic moment materials such as CoFe. Note that these materials are provided by way of example only, and other materials may be used. Additional layers such as insulation between the shields and/or pole tips and an insulation layer surrounding the sensor may be present. Illustrative materials for the insulation include alumina and other oxides, insulative polymers, etc.

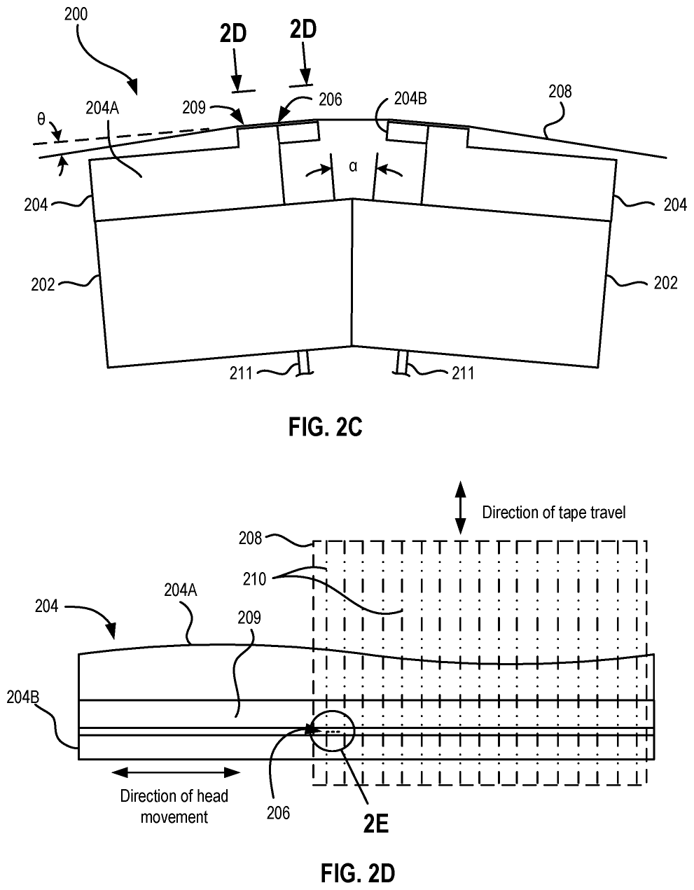

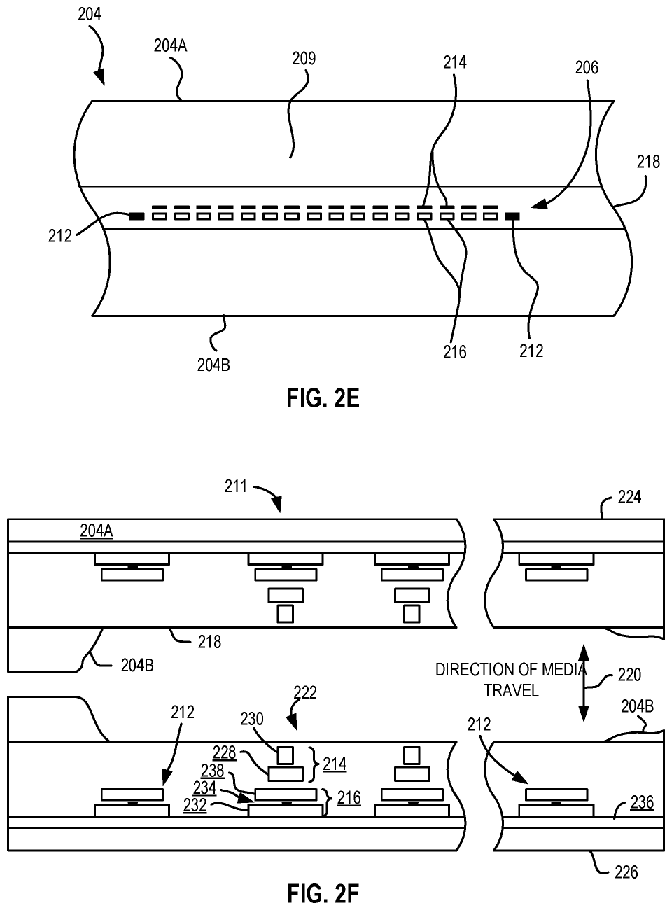

The configuration of the tape head 211 according to one embodiment includes multiple modules, preferably three or more. In a write-read-write (W-R-W) head, outer modules for writing flank one or more inner modules for reading. Referring to FIG. 3, depicting a W-R-W configuration, the outer modules 252, 256 each include one or more arrays of write transducers 260. The inner module 254 of FIG. 3 includes one or more arrays of read transducers 258 in a similar configuration. Variations of a multi-module head include a R-W-R head (FIG. 4), a R-R-W head, a W-W-R head, etc. In yet other variations, one or more of the modules may have read/write pairs of transducers. Moreover, more than three modules may be present. In further approaches, two outer modules may flank two or more inner modules, e.g., in a W-R-R-W, a R-W-W-R arrangement, etc. For simplicity, a W-R-W head is used primarily herein to exemplify embodiments of the present invention. One skilled in the art apprised with the teachings herein will appreciate how permutations of the present invention would apply to configurations other than a W-R-W configuration.

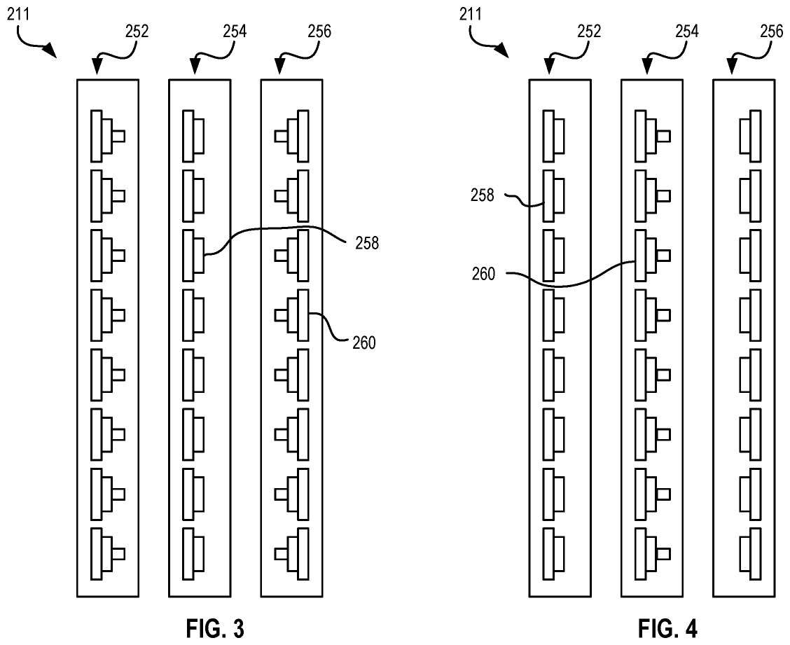

FIG. 5 illustrates a magnetic head 211 according to one embodiment of the present invention that includes first, second and third modules 302, 304, 306 each having a tape bearing surface 308, 310, 312 respectively, which may be flat, contoured, etc. Note that while the term “tape bearing surface” appears to imply that the surface facing the tape 315 is in physical contact with the tape bearing surface, this is not necessarily the case. Rather, only a portion of the tape may be in contact with the tape bearing surface, constantly or intermittently, with other portions of the tape riding (or “flying”) above the tape bearing surface on a layer of air, sometimes referred to as an “air bearing.” The first module 302 will be referred to as the “leading” module as it is the first module encountered by the tape in a three module design for tape moving in the indicated direction. The third module 306 will be referred to as the “trailing” module. The trailing module follows the middle module and is the last module seen by the tape in a three module design. The leading and trailing modules 302, 306 are referred to collectively as outer modules. Also note that the outer modules 302, 306 will alternate as leading modules, depending on the direction of travel of the tape 315.

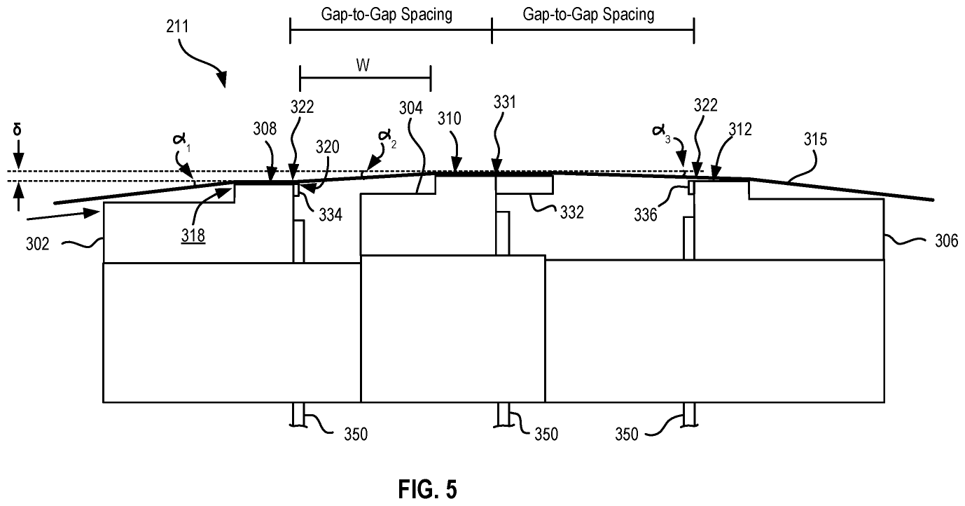

In one embodiment, the tape bearing surfaces 308, 310, 312 of the first, second and third modules 302, 304, 306 lie on about parallel planes (which is meant to include parallel and nearly parallel planes, e.g., between parallel and tangential as in FIG. 6), and the tape bearing surface 310 of the second module 304 is above the tape bearing surfaces 308, 312 of the first and third modules 302, 306. As described below, this has the effect of creating the desired wrap angle α₂ of the tape relative to the tape bearing surface 310 of the second module 304.

Where the tape bearing surfaces 308, 310, 312 lie along parallel or nearly parallel yet offset planes, intuitively, the tape should peel off of the tape bearing surface 308 of the leading module 302. However, the vacuum created by a skiving edge 318 of the leading module 302 has been found by experimentation to be sufficient to keep the tape adhered to the tape bearing surface 308 of the leading module 302. A trailing edge 320 of the leading module 302 (the end from which the tape leaves the leading module 302) is the approximate reference point which defines the wrap angle α₂ over the tape bearing surface 310 of the second module 304. The tape stays in close proximity to the tape bearing surface until close to the trailing edge 320 of the leading module 302. Accordingly, transducers 322 may be located near the trailing edges of the outer modules 302, 306. These embodiments are particularly adapted for write-read-write applications.

A benefit of this and other embodiments described herein is that, because the outer modules 302, 306 are fixed at a determined offset from the second module 304, the inner wrap angle α₂ is fixed when the modules 302, 304, 306 are coupled together or are otherwise fixed into a head. The inner wrap angle α₂ is approximately tan⁻¹(δ/W) where δ is the height difference between the planes of the tape bearing surfaces 308, 310 and W is the width between the opposing ends of the tape bearing surfaces 308, 310. An illustrative inner wrap angle α₂ is in a range of about 0.3° to about 1.1°, though can be any angle required by the design.

Beneficially, the inner wrap angle α₂ on the side of the module 304 receiving the tape (leading edge) will be larger than the inner wrap angle α3 on the trailing edge, as the tape 315 rides above the trailing module 306. This difference is generally beneficial as a smaller α₃ tends to oppose what has heretofore been a steeper exiting effective wrap angle.

Note that the tape bearing surfaces 308, 312 of the outer modules 302, 306 are positioned to achieve a negative wrap angle at the trailing edge 320 of the leading module 302. This is generally beneficial in helping to reduce friction due to contact with the trailing edge 320, provided that proper consideration is given to the location of the crowbar region that forms in the tape where it peels off the head. This negative wrap angle also reduces flutter and scrubbing damage to the elements on the leading module 302. Further, at the trailing module 306, the tape 315 flies over the tape bearing surface 312 so there is virtually no wear on the elements when tape is moving in this direction. Particularly, the tape 315 entrains air and so will not significantly ride on the tape bearing surface 312 of the third module 306 (some contact may occur). This is permissible, because the leading module 302 is writing while the trailing module 306 is idle.

Writing and reading functions are performed by different modules at any given time. In one embodiment, the second module 304 includes a plurality of data and optional servo readers 331 and no write transducers. The first and third modules 302, 306 include a plurality of write transducers 322 and no data read transducers, with the exception that the outer modules 302, 306 may include optional servo readers. The servo readers may be used to position the head during reading and/or writing operations. The servo reader(s) on each module are typically located towards the end of the array of read transducers or write transducers.

By having only read transducers or side by side write transducers and servo readers in the gap between the substrate and closure, the gap length can be substantially reduced. Typical heads have piggybacked read transducers and write transducers, where the write transducer is formed above each read transducer. A typical gap is 20-35 microns. However, irregularities on the tape may tend to droop into the gap and create gap erosion. Thus, the smaller the gap the better. The smaller gap enabled herein exhibits fewer wear related problems.

In some embodiments, the second module 304 has a closure, while the first and third modules 302, 306 do not have a closure. Where there is no closure, preferably a hard coating is added to the module. One preferred coating is diamond-like carbon (DLC).

In the embodiment shown in FIG. 5, the first, second, and third modules 302, 304, 306 each have a closure 332, 334, 336, which extends the tape bearing surface of the associated module, thereby effectively positioning the read/write elements away from the edge of the tape bearing surface. The closure 332 on the second module 304 can be a ceramic closure of a type typically found on tape heads. The closures 334, 336 of the first and third modules 302, 306, however, may be shorter than the closure 332 of the second module 304 as measured parallel to a direction of tape travel over the respective module. This enables positioning the modules closer together. One way to produce shorter closures 334, 336 is to lap the standard ceramic closures of the second module 304 an additional amount. Another way is to plate or deposit thin film closures above the elements during thin film processing. For example, a thin film closure of a hard material such as Sendust or nickel-iron alloy (e.g., 45/55) can be formed on the module.

With reduced-thickness ceramic or thin film closures 334, 336 or no closures on the outer modules 302, 306, the write-to-read gap spacing can be reduced to less than about 1 mm, e.g., about 0.75 mm, or 50% less than commonly-used linear tape open (LTO) tape head spacing. The open space between the modules 302, 304, 306 can still be set to approximately 0.5 to 0.6 mm, which in some embodiments is ideal for stabilizing tape motion over the second module 304.

Depending on tape tension and stiffness, it may be desirable to angle the tape bearing surfaces of the outer modules relative to the tape bearing surface of the second module. FIG. 6 illustrates an embodiment where the modules 302, 304, 306 are in a tangent or nearly tangent (angled) configuration. Particularly, the tape bearing surfaces of the outer modules 302, 306 are about parallel to the tape at the desired wrap angle α₂ of the second module 304. In other words, the planes of the tape bearing surfaces 308, 312 of the outer modules 302, 306 are oriented at about the desired wrap angle α₂ of the tape 315 relative to the second module 304. The tape will also pop off of the trailing module 306 in this embodiment, thereby reducing wear on the elements in the trailing module 306. These embodiments are particularly useful for write-read-write applications. Additional aspects of these embodiments are similar to those given above.

Typically, the tape wrap angles may be set about midway between the embodiments shown in FIGS. 5 and 6.

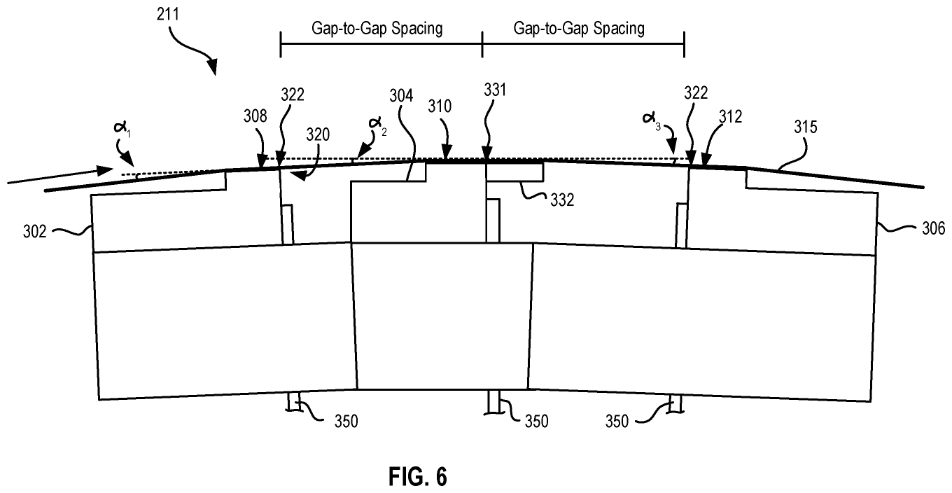

FIG. 7 illustrates an embodiment where the modules 302, 304, 306 are in an overwrap configuration. Particularly, the tape bearing surfaces 308, 312 of the outer modules 302, 306 are angled slightly more than the tape 315 when set at the desired wrap angle α₂ relative to the second module 304. In this embodiment, the tape does not pop off of the trailing module, allowing it to be used for writing or reading. Accordingly, the leading and middle modules can both perform reading and/or writing functions while the trailing module can read any just-written data. Thus, these embodiments are preferred for write-read-write, read-write-read, and write-write-read applications. In the latter embodiments, closures should be wider than the tape canopies for ensuring read capability. The wider closures may require a wider gap-to-gap separation. Therefore, a preferred embodiment has a write-read-write configuration, which may use shortened closures that thus allow closer gap-to-gap separation.

Additional aspects of the embodiments shown in FIGS. 6 and 7 are similar to those given above.

A 32 channel version of a multi-module tape head 211 may use cables 350 having leads on the same or smaller pitch as current 16 channel piggyback LTO modules, or alternatively the connections on the module may be organ-keyboarded for a 50% reduction in cable span. Over-under, writing pair unshielded cables may be used for the write transducers, which may have integrated servo readers.

The outer wrap angles α₁ may be set in the drive, such as by guides of any type known in the art, such as adjustable rollers, slides, etc. or alternatively by outriggers, which are integral to the head. For example, rollers having an offset axis may be used to set the wrap angles. The offset axis creates an orbital arc of rotation, allowing precise alignment of the wrap angle α₁.

To assemble any of the embodiments described above, conventional u-beam assembly can be used. Accordingly, the mass of the resultant head may be maintained or even reduced relative to heads of previous generations. In other approaches, the modules may be constructed as a unitary body. Those skilled in the art, armed with the present teachings, will appreciate that other known methods of manufacturing such heads may be adapted for use in constructing such heads. Moreover, unless otherwise specified, processes and materials of types known in the art may be adapted for use in various embodiments in conformance with the teachings herein, as would become apparent to one skilled in the art upon reading the present disclosure.

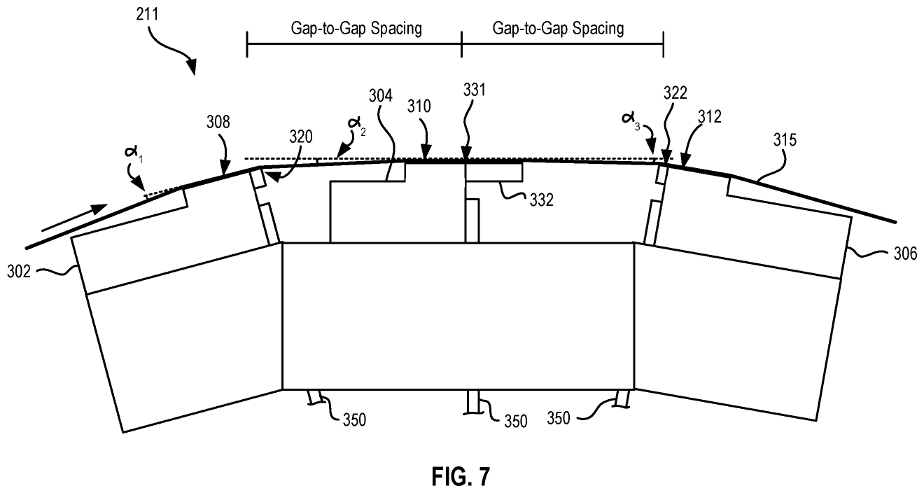

As a tape is run over a module, it is preferred that the tape passes sufficiently close to magnetic transducers on the module such that reading and/or writing is efficiently performed, e.g., with a low error rate. According to some approaches, tape tenting may be used to ensure the tape passes sufficiently close to the portion of the module having the magnetic transducers. To better understand this process, FIGS. 8A-8C illustrate the principles of tape tenting. FIG. 8A shows a module 800 having an upper tape bearing surface 802 extending between opposite edges 804, 806. A stationary tape 808 is shown wrapping around the edges 804, 806. As shown, the bending stiffness of the tape 808 lifts the tape off of the tape bearing surface 802. Tape tension tends to flatten the tape profile, as shown in FIG. 8A. Where tape tension is minimal, the curvature of the tape is more parabolic than shown.

FIG. 8B depicts the tape 808 in motion. The leading edge, i.e., the first edge the tape encounters when moving, may serve to skive air from the tape, thereby creating a subambient air pressure between the tape 808 and the tape bearing surface 802. In FIG. 8B, the leading edge is the left edge and the right edge is the trailing edge when the tape is moving left to right. As a result, atmospheric pressure above the tape urges the tape toward the tape bearing surface 802, thereby creating tape tenting proximate each of the edges. The tape bending stiffness resists the effect of the atmospheric pressure, thereby causing the tape tenting proximate both the leading and trailing edges. Modeling predicts that the two tents are very similar in shape.

FIG. 8C depicts how the subambient pressure urges the tape 808 toward the tape bearing surface 802 even when a trailing guide 810 is positioned above the plane of the tape bearing surface.

It follows that tape tenting may be used to direct the path of a tape as it passes over a module. As previously mentioned, tape tenting may be used to ensure the tape passes sufficiently close to the portion of the module having the magnetic transducers, preferably such that reading and/or writing is efficiently performed, e.g., with a low error rate.

Magnetic tapes may be stored in tape cartridges that are, in turn, stored at storage slots or the like inside a data storage library. The tape cartridges may be stored in the library such that they are accessible for physical retrieval. In addition to magnetic tapes and tape cartridges, data storage libraries may include data storage drives that store data to, and/or retrieve data from, the magnetic tapes. Moreover, tape libraries and the components included therein may implement a file system which enables access to tape and data stored on the tape.

File systems may be used to control how data is stored in, and retrieved from, memory. Thus, a file system may include the processes and data structures that an operating system uses to keep track of files in memory, e.g., the way the files are organized in memory. Linear Tape File System (LTFS) is an exemplary format of a file system that may be implemented in a given library in order to enable access to compliant tapes. It should be appreciated that various embodiments herein can be implemented with a wide range of file system formats, including for example IBM® Spectrum® Archive Library Edition (LTFS LE) (IBM and all IBM-based trademarks and logos are trademarks or registered trademarks of International Business Machines Corporation and/or its affiliates). However, to provide a context, and solely to assist the reader, some of the embodiments below may be described with reference to LTFS, which is a type of file system format. This has been done by way of example only, and should not be deemed limiting on the invention defined in the claims.

A tape cartridge may be “loaded” by inserting the cartridge into the tape drive, and the tape cartridge may be “unloaded” by removing the tape cartridge from the tape drive. Once loaded in a tape drive, the tape in the cartridge may be “threaded” through the drive by physically pulling the tape (the magnetic recording portion) from the tape cartridge, and passing it above a magnetic head of a tape drive. Furthermore, the tape may be attached on a take-up reel (e.g., see 205 of FIG. 2A above) to move the tape over the magnetic head.

Once threaded in the tape drive, the tape in the cartridge may be “mounted” by reading metadata on a tape and bringing the tape into a state where the LTFS is able to use the tape as a constituent component of a file system. Moreover, in order to “unmount” a tape, metadata is preferably first written on the tape (e.g., as an index), after which the tape may be removed from the state where the LTFS is allowed to use the tape as a constituent component of a file system. Finally, to “unthread” the tape, the tape is unattached from the take-up reel and is physically placed back into the inside of a tape cartridge again. The cartridge may remain loaded in the tape drive even after the tape has been unthreaded, e.g., waiting for another read and/or write request. However, in other instances, the tape cartridge may be unloaded from the tape drive upon the tape being unthreaded, e.g., as described above.

Magnetic tape is a sequential access medium. Thus, new data is written to the tape by appending the data at the end of previously written data. It follows that when data is recorded in a tape having only one partition, metadata (e.g., allocation information) is continuously appended to an end of the previously written data as it frequently updates and is accordingly rewritten to tape. As a result, the rearmost information is read when a tape is first mounted in order to access the most recent copy of the metadata corresponding to the tape. However, this introduces a considerable amount of delay in the process of mounting a given tape.

To overcome this delay caused by single partition tape mediums, the LTFS format includes a tape that is divided into two partitions, which include an index partition and a data partition. The index partition may be configured to record metadata (meta information), e.g., such as file allocation information (Index), while the data partition may be configured to record the body of the data, e.g., the data itself.

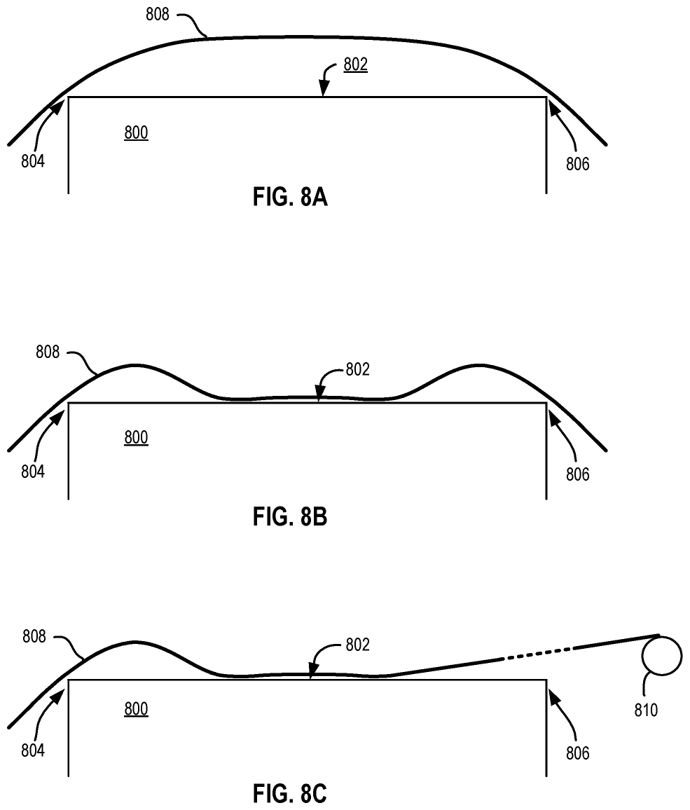

Looking to FIG. 9, a magnetic tape 900 having an index partition 902 and a data partition 904 is illustrated, according to one embodiment. As shown, data files and indexes are stored on the tape. The LTFS format allows for index information to be recorded in the index partition 902 at the beginning of tape 906, as would be appreciated by one skilled in the art upon reading the present description.

As index information is updated, it preferably overwrites the previous version of the index information, thereby allowing the currently updated index information to be accessible at the beginning of tape in the index partition. According to the specific example illustrated in FIG. 9, a most recent version of metadata Index 3 is recorded in the index partition 902 at the beginning of the tape 906. Conversely, all three versions of metadata Index 1, Index 2, Index 3 as well as data File A, File B, File C, File D are recorded in the data partition 904 of the tape. Although Index 1 and Index 2 are old (e.g., outdated) indexes, because information is written to tape by appending it to the end of the previously written data as described above, these old indexes Index 1, Index 2 remain stored on the tape 900 in the data partition 904 without being overwritten.

The metadata may be updated in the index partition 902 and/or the data partition 904 the same or differently depending on the desired embodiment. According to some embodiments, the metadata of the index and/or data partitions 902, 904 may be updated in response to the tape being unmounted, e.g., such that the index may be read quickly from the index partition when that tape is mounted again. The metadata is preferably also written in the data partition 904 so the tape may be mounted using the metadata recorded in the data partition 904, e.g., as a backup option.

According to one example, which is no way intended to limit the invention, LTFS LE may be used to provide the functionality of writing an index in the data partition when a user explicitly instructs the system to do so, or at a time designated by a predetermined period which may be set by the user, e.g., such that data loss in the event of sudden power stoppage can be mitigated.

When a large size of data, for example a file, is written by a storage device such as a tape drive or disk drive, the file is stored on the device as a ‘data block’ which has a smaller size and is easy to handle by the device. When the storage device was not able to read one data block from the number of data blocks which together form the file, the result was a failure to read the entire file.

A storage device has a variety of error recovery procedures to read back the data. These procedures are generally referred to as ERPs (Error Recovery Procedures). In general, an ERP sequence implements a variety of methods to avoid the read error, and the time it takes to read data is much longer than a normal read operation. Furthermore, even after the longer time of performing ERPs, it is possible that the data is ultimately not able to be read. In this case, the time spent trying the various ERPs is wasted.

On a tape storage device according to preferred embodiments, to allow continued data transfer during the pause time caused by stop and start of tape media, e.g., during an ERP, data is pre-read by a ‘read ahead’ feature and stored in a large sized buffer. Particularly, data recorded in the forward area is read and stored in the buffer before a user requests to read the data, so that the data is available if requested. When the read ahead feature is reading the data, the device may perform ERP for any portions of data that are hard to read. Sometimes, all relevant ERPs are performed, but the drive is not able to read the data successfully. Such error is generally referred to as an unrecoverable error, or “perm.”

In conventional storage systems, when there is an unrecoverable error in data read ahead, the error remains unknown until the data which were not able to be read is actually requested. This is because it is not known if the data which failed to read in ‘read ahead’ operations would actually be requested.

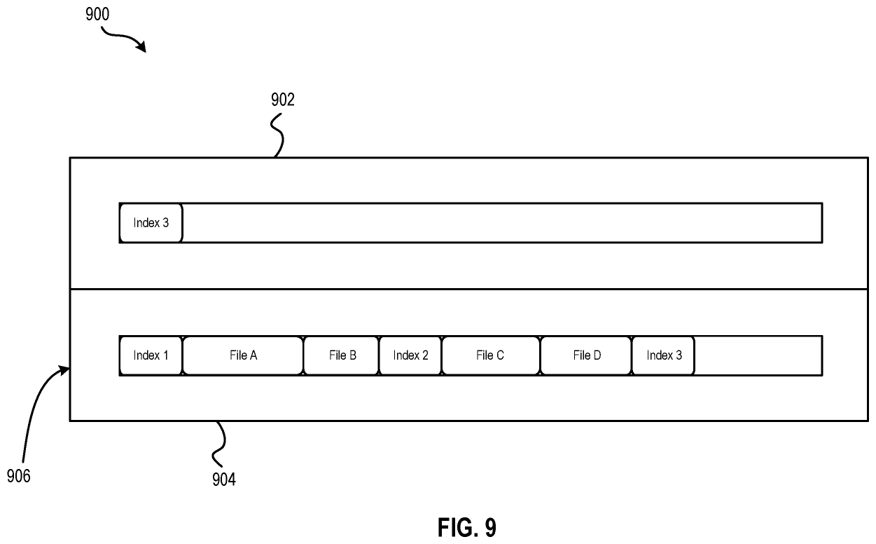

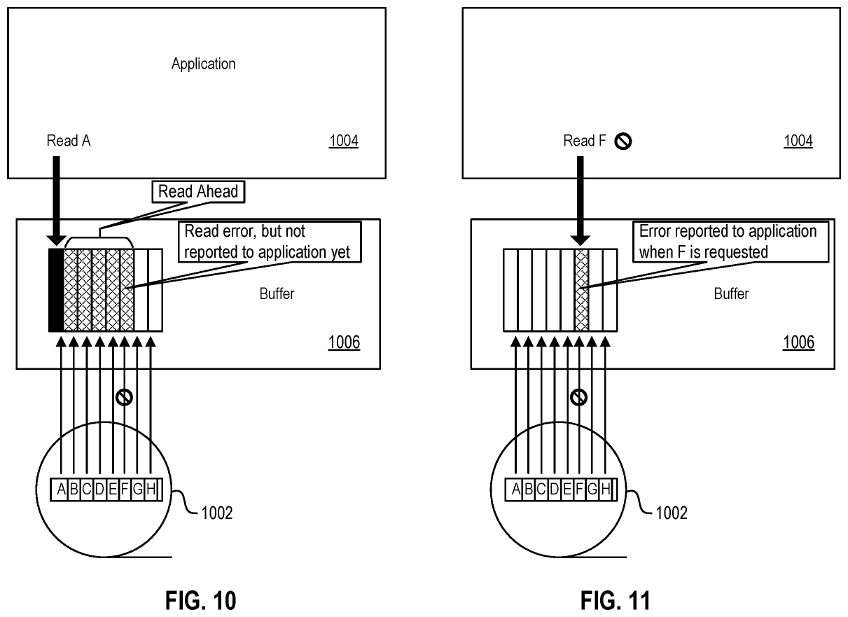

FIG. 10 graphically represents a tape drive encountering a failure while reading record F from a magnetic recording tape 1002 during a read ahead operation while an application 1004 reads record A. Records located on the tape 1002 subsequent to Record A are read and stored in the buffer 1006. The error is not reported at that time, and the error remains unknown until record F is requested by the application. In FIG. 11, when record F is requested by the application, the error in record F is reported to the application.

Prior to the present invention, the application is not able to read the complete file when there is a part of the data which is unreadable. It follows that the application would be better off not reading the file from this tape. However, the application does not know if the entire file is readable or not until it requests the data which is not readable. On the other hands, the drive already knows the failure exists since it has encountered the error during the read ahead operation, but it was not able to report the error to the application because there was no method to provide notice about the error.

Various embodiments of the present invention reduce the aforementioned costs both on the application (e.g., reading part of file though it eventually failed to read the entire file) and drive (e.g., waiting for the request to read the failed record which was read in the read ahead operation). Particularly, in one general embodiment, a storage device such as a tape drive, a tape library, etc. reports that an error will happen within a given range of data blocks when a read ahead feature finds the error in advance of the data currently requested by a requestor, e.g., a host, application, library controller, etc.

Thus, the requestor is then able to select whether it continues to read data from the storage device, or stops the reading, according to its purpose of data reading. The requestor is able to judge, at an earlier timing that was heretofore available, whether to continue or to stop the reading operation. Moreover, the storage device is able to reduce the time it keeps the read-ahead data in the buffer memory, as such data would not eventually be used by the requestor.

For context, and to aid the reader, some of the description below refers to new exemplary commands that are used in various embodiments. The following new commands are exemplary, and can be used with a storage device, in accordance with various embodiments.

A SetReadRange command is a command to set a range of a series of data blocks to be read by an application. The SetReadRange command sets a range of target data blocks from the current position to a designated block number.

After a SetReadRange command has been issued, a Read command reports an error at the point at which a storage device detects occurrence of an error in data blocks within a set range. If occurrence of the error within the range of data blocks is already known at the point of issuance of the SetReadRange command, the SetReadRange command causes the error to be reported.

When a Read command returns an error after SetReadRange command was issued or when a different command directs the storage device to move out of the set range (e.g., via a Locate/Space command), or a Read command directed to data blocks outside the range is issued, the range of data blocks set by the SetReadRange command is cleared.

In the examples that follow, and presented by way of example only, a tape storage device implementing SCSI commands is used as an example of storage device to explain an implementation as follows.

### How to Process SetReadRange Command

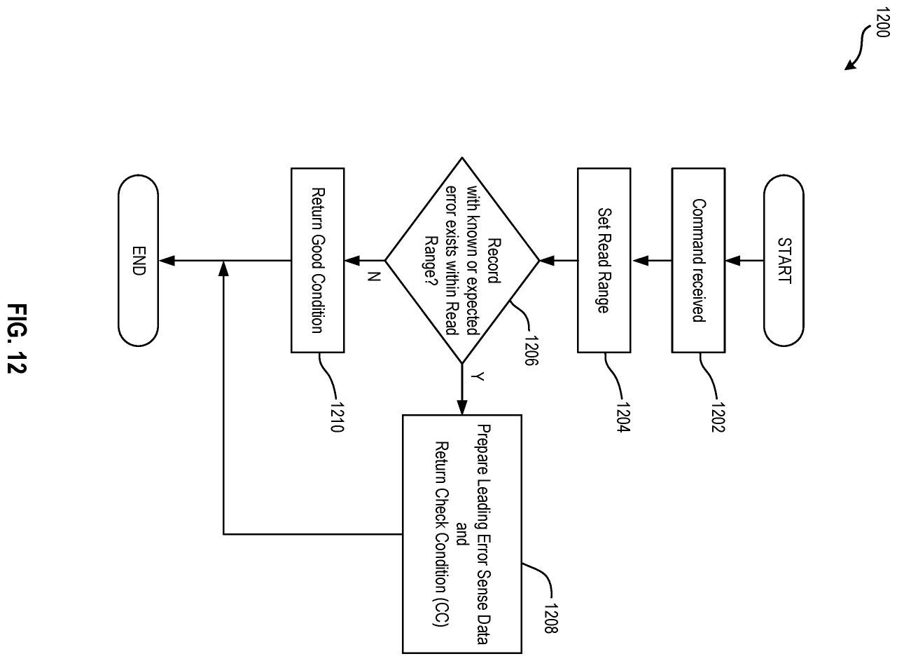

Referring to FIG. 12, a flowchart of a method 1200 for processing a SetReadRange command is shown, according to one embodiment. The method 1200 may be performed in accordance with the present invention in any of the environments depicted in FIGS. 1-11, among others, in various embodiments. Of course, more or fewer operations than those specifically described in FIG. 12 may be included in method 1200, as would be understood by one of skill in the art upon reading the present descriptions.

Each of the steps of the method 1200 may be performed by any suitable component of the operating environment. For example, in various embodiments, the method 1200 may be partially or entirely performed by a data storage device such as a tape drive, a disk drive, a data storage library, or some other device having one or more processors therein. The processor, e.g., processing circuit(s), chip(s), and/or module(s) implemented in hardware and/or software, and preferably having at least one hardware component may be utilized in any device to perform one or more steps of the method 1200. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 12, method 1200 may initiate with operation 1202, in which a SetReadRange command is received at a data storage device that performs data operations on magnetic media. The SetReadRange command indicates a Read Range of records. The command may be received from a requestor, e.g., a host, an application running on a host, a library controller, etc. In one example, the records refer to data blocks stored on a magnetic recording tape.

In operation 1204, the Read Range is set. In some approaches, the Read Range is set, but records are not read at this point. Rather, information about errors previously encountered in the records can be examined, e.g., as described below. In other approaches, the data storage device performs a read ahead operation, whereby the device reads and stores records in the Read Range within a memory (e.g., buffer) of the device. The read-ahead records may be used as normal read-ahead data would be used, and/or for determining whether one or more of the records within the Read Range causes an error.

In operation 1206, a determination is made as to whether one or more of the records within the Read Range is expected to cause an error. The error may be found in the read-ahead of records noted above. For example, determining whether one or more of the records within the Read Range is expected to cause an error includes checking a result of a read ahead of records falling within the Read Range for indication of an error encountered during the read ahead. The indication can be a leading error flag.

Strictly speaking, occurrence of an error is generally not known until actual reading of the records from a tape medium is performed. However, as alluded to above, the error may have been found previously, e.g., during a prior read operation, and information about the error stored, e.g., its location on tape, which records are affected, whether the error was recoverable, etc. For example, some tape drives may record a position of an error occurring on a tape medium as statistical information, e.g., the location of an error previously encountered on a tape is stored in association with the tape, e.g., in cartridge memory. By using such information, occurrence of an error within the Read Range can be assumed without reading the tape. A probability of occurrence of an of error may be further calculated based on statistical information so as to be used to determine whether an error will occur or not.

In operation 1208, in response to determining that one or more of the records within the Read Range is known to cause an error, an indication indicative of the record known to (or equivalently, expected to) cause the error is returned. As noted above, the determination that an error is or will be found when reading records in the Read Range can be based on the current reading operation of records into the buffer, based on previously stored information about an error in a record in the Read Range, etc.

In a preferred approach, when there is a record having (or expected to have) an error within the Read Range, the SetReadRange command returns CC (Check Condition, indicating a status after execution of the SCSI command, CC indicates the presence of sense data storing an error code of the SCSI command, etc.) and returns, to a subsequent RequestSense command, sense data indicating occurrence of an error within the Read Range (herein referred to as Leading Error Sense Data).

In operation 1210, when there is no record causing an error within the Read Range, the SetReadRange command is discontinued without making any changes. An indication of a good condition of the records within the Read Range may be returned.

### How to Process Read Command

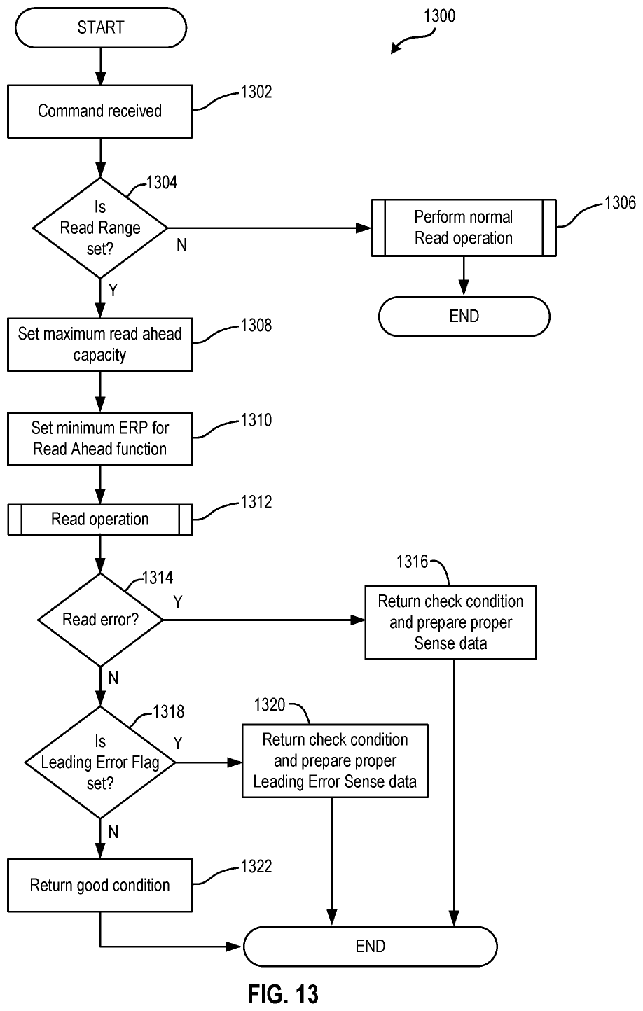

Now referring to FIG. 13, a flowchart of a method 1300 for processing a Read command is shown, according to one embodiment. The method 1300 may be performed in accordance with the present invention in any of the environments depicted in FIGS. 1-12, among others, in various embodiments. Of course, more or fewer operations than those specifically described in FIG. 13 may be included in method 1300, as would be understood by one of skill in the art upon reading the present descriptions.

Each of the steps of the method 1300 may be performed by any suitable component of the operating environment. For example, in various embodiments, the method 1300 may be partially or entirely performed by a data storage device such as a tape drive, a disk drive, a data storage library, or some other device having one or more processors therein. The processor, e.g., processing circuit(s), chip(s), and/or module(s) implemented in hardware and/or software, and preferably having at least one hardware component may be utilized in any device to perform one or more steps of the method 1300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 13, method 1300 may initiate with operation 1302, where the data storage device receives a Read command indicating one or more target records to read.

At decision 1304, a determination is made as to whether a Read Range is set, e.g., within a memory of the device. The Read Range may have been set in response to receiving a SetReadRange command that sets the Read Range.

If a Read Range is not set, the device executes the Read command in a conventional manner in operation 1306 for returning the target records indicated in the Read command.

If a Read Range is set, a maximum volume (e.g., maximum number of records) to read ahead using a Read Ahead feature (e.g., a feature to read ahead records other than a requested target record when reading records) in operation 1308. The maximum number of records to read ahead may be based on the Read Range.

In operation 1310, the device may set a limit on ERP process to be executed upon occurrence of an error when executing the Read Ahead operation. Preferably, the Read Ahead operation is performed after the target data designated by the Read Command was read to satisfy the Read command. For example, the most minimal process is to perform no ERP. In other approaches, minimal ERP may include performing a single ERP, such as performing one backhitch and reread of the data, determining whether the error can be recovered using Error Correction Code (ECC), etc.

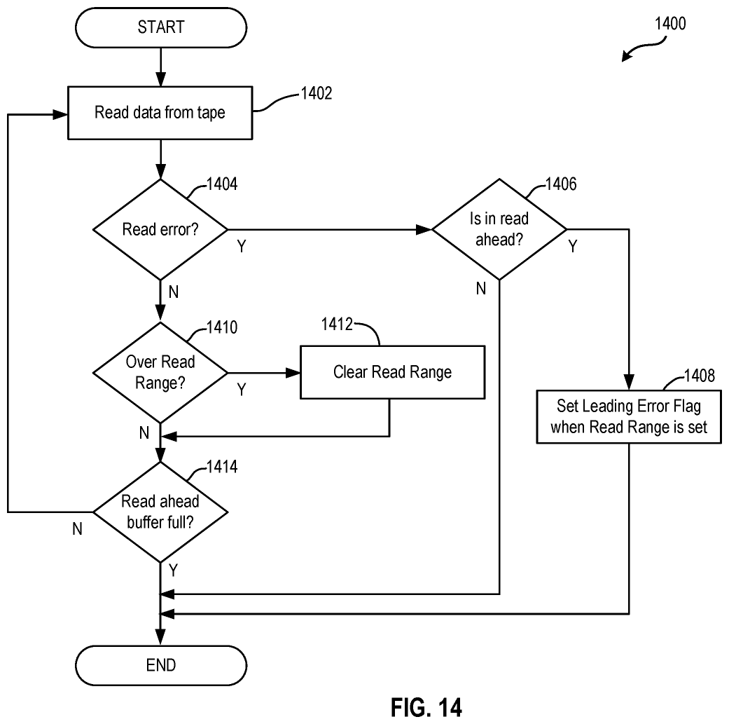

In operation 1312, the target records are read to satisfy the Read command, and the Read Ahead operation of additional records is performed according to the number of records to read ahead. When an error occurs when reading one of the additional records during Read Ahead, the device sets a Leading Error flag within the memory, preferably indicating which target record caused the error. See method 1400 of FIG. 14, for an exemplary process for performing operation 1312.

At decision 1314 of FIG. 13, a determination is made as to whether an error was encountered when reading the target record that satisfies the Read command.

When an error is encountered while reading the record designated by the Read command, the device reports the error in a conventional manner in operation 1316.

When there is no error upon completion of reading the record designated by the Read command, the device may return a Good Condition in a conventional manner. However, if a Read Range is set, the device checks whether there is a Leading Error flag in operation 1318.

If a Leading Error flag is set, a CC is returned, as well as Leading Error Sense Data, to a subsequent RequestSense Command. See operation 1320. For example, an indication indicative of the record that caused the error during the read ahead operation according to the leading error flag may be send, e.g., to a source of the read request, to a data library storage controller, etc. The application that sent the read request may then decide whether to retrieve more records, including the problematic record, whether to request an alternate copy of the problematic record from another recording medium, etc.

If a Leading Error flag is not set, the device returns a Good Condition in a conventional manner in operation 1322.

Upon completion of a read process to read any data within the Read Range, the memory storing records in the Read Range is cleared. In a subsequent Read command, a normal Read Command procedure is activated and when the remaining amount of data subjected to Read Ahead falls below a specified value, a conventional Read Ahead process is executed.

When a normal read process is configured so as not to read data which was already regarded as having an error, data detected as having an error when the ReadRange is set is marked to indicate the error, thereby allowing a normal Read Command executed after clearance of the ReadRange to read data using normal ERP again.

Now referring to FIG. 14, a flowchart of a method 1400 for reading data (e.g., as in operation 1312 of FIG. 13) when Read Range is set is shown, according to one embodiment. The method 1400 may be performed in accordance with the present invention in any of the environments depicted in FIGS. 1-13, among others, in various embodiments. Of course, more or fewer operations than those specifically described in FIG. 14 may be included in method 1400, as would be understood by one of skill in the art upon reading the present descriptions.

Each of the steps of the method 1400 may be performed by any suitable component of the operating environment. For example, in various embodiments, the method 1400 may be partially or entirely performed by a data storage device such as a tape drive, a disk drive, a data storage library, or some other device having one or more processors therein. The processor, e.g., processing circuit(s), chip(s), and/or module(s) implemented in hardware and/or software, and preferably having at least one hardware component may be utilized in any device to perform one or more steps of the method 1400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 14, method 1400 may initiate with operation 1402, where data is read from a storage medium, e.g., magnetic tape, in response to receiving a Read command. The reading includes the requested target record, as well as read ahead of records within the Read Range.

If a read error is discovered at decision 1404, a determination is made at decision 1406 as to whether the error was for a record being read ahead. If so, a Leading Error flag is set 1408. If not, the read error is handled using conventional ERP.

If no read error was discovered at decision 1404, then a determination is made as to whether all records in the Read Range have been read. See decision 1410. If all records in the Read Range have been read, then the Read Range is cleared from memory in operation 1412.

After operation 1412, or if not all records in the Read Range have been read, the process continues to decision 1414, where a determination is made as to whether the read ahead buffer is full. If the buffer is not full, the process may return to operation 1402, e.g., to process more records within the Read Range. If the buffer is full, the process ends.

### How to Process a Locate or Space Command

When receiving a Locate command or Space command, Read Range within the memory is cleared. However, there may also be an implementation in which Read Range is not cleared when the Command does not require read data from a tape medium and is completed with positioning within a buffer.

### Requestor-Side Processes

LTFS allowing data recorded in a tape storage device to be used through a file system is explained here as an application example. This has been done by way of example only.

When LTFS receives a request to read a file, LTFS isses, to a tape storage device to which a tape cartridge storing the file is mounted, a Read command to read from a recording position of target data. The recording position of the target data is described in an index file of LTFS and the size of the file is also recorded therein. It is therefore possible to calculate a range of record numbers used to record the file from the information recorded in the index file.

Requestors such as applications may use the following procedure to read a target file.

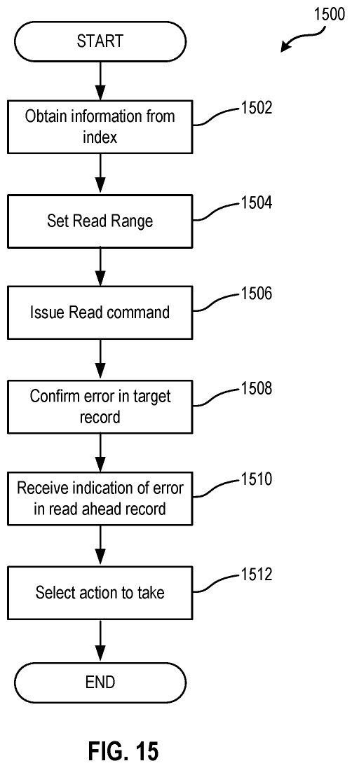

Now referring to FIG. 15, a flowchart of a method 1500 is shown according to one embodiment. The method 1500 may be performed in accordance with the present invention in any of the environments depicted in FIGS. 1-14, among others, in various embodiments. Of course, more or fewer operations than those specifically described in FIG. 15 may be included in method 1500, as would be understood by one of skill in the art upon reading the present descriptions.

Each of the steps of the method 1500 may be performed by any suitable component of the operating environment. For example, in various embodiments, the method 1500 may be partially or entirely performed by a host computer, a storage controller, or some other device having one or more processors therein. The processor, e.g., processing circuit(s), chip(s), and/or module(s) implemented in hardware and/or software, and preferably having at least one hardware component may be utilized in any device to perform one or more steps of the method 1500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 15, method 1500 may initiate with operation 1502, where an application obtains a range of records in which a target record is recorded from an index file.

In operation 1504, the application uses SetReadRange Command to set a Read Range. The application may finish reading the file if SetReadRange Command returns an error.

In operation 1506, a Read command is issued to start sequential reading of target records constituting the file. The target record may be received.

If Read command reports an error, the application may use a Request Sense Command to confirm details of the error in operation 1508.

An indication indicative of a record within the read range that caused an error during a read ahead operation of records within the read range may be received in operation 1510. For example, if Leading Error Sense Data is returned, the application reports a file reading error at that point.

Using the information received in operation 1510, the application may determine whether to finish reading the file, or seek the target record associated with the error from another source. See operation 1512. If reading fails, the method may move on to a conventional process carried out when a file cannot be read from the tape.

For example, when the same file is recorded redundantly, a possible subsequent process is to try to read said file from another tape storing the same file.

Alternatively, if it is preferred to try to read such a file from a subject tape, as well as possible and/or regardless of the time it takes, the file may be read continuously according to normal Read command issued continuously. Once Leading Error Sense Data is issued, the device executes a normal Read process and applies error recovery processes to a troubled area in a possible range. As a result, data may be read from the tape in some cases.

As stated above, various embodiments of the present invention allow requestors to select whether to attempt to read possibly error-prone records, or to attempt to obtain such records from an alternative source. Accordingly, the cost of time can be reduced.

The foregoing methodology is particularly effective when multiple tape cartridges are used in a manner similar to RAID with Erasure Coding. For Example, when a file is separated into two blocks and two parity blocks, the file is distributed to four tape cartridges. On read (or recall) operation, two of four blocks are required. The software which utilizes erasure coding will try to read two blocks. When the target record is not able to be read, the process tries to read other blocks. With the foregoing methodology, knowledge that the block is not readable is known early, thereby improving total performance of a recall operation on a distributed system using erasure coding.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, at a data storage device that performs data operations on magnetic media, a command indicating a read range of records to read;
determining whether one or more of the records within the read range is expected to cause an error; and
in response to determining that one or more of the records within the read range is known to cause an error, returning an indication indicative of the record known to cause the error.

2. A method as recited in claim 1, wherein the data storage device is a tape drive.

3. A method as recited in claim 1, comprising performing, in response to receiving the command, a read ahead of the records within the read range for determining whether one or more of the records within the read range causes an error.

4. A method as recited in claim 1, wherein determining whether one or more of the records within the read range is expected to cause an error includes checking a result of a read ahead of records falling within the read range for indication of an error encountered during the read ahead.

5. A method as recited in claim 1, wherein determining whether one or more of the records within the read range is expected to cause an error includes using existing information about the records in the read range to determine that an error has previously been encountered for the one or more of the records.

6. An apparatus, comprising:
a magnetic head; and
a controller coupled to the magnetic head, the controller being configured to perform the method of claim 1.

7. A computer program product, the computer program product comprising:
one or more computer readable storage media, and program instructions collectively stored on the one or more computer readable storage media, the program instructions comprising:
program instructions to perform the method of claim 1.

8. A method, comprising:
receiving, at a data storage device that performs data operations on magnetic media, a read command indicating target records to read;
determining whether a read range is set;
in response to determining that no read range is set, performing a normal read operation for returning the target records indicated in the read command;
in response to determining that a read range is set:
setting a number of records to read ahead based on the read range;
reading the target records requested by the read command and performing a read ahead operation of additional records according to the number of records to read ahead;
in response to determining that one of the additional records read during the read ahead operation has an error, setting a flag indicative of the target record causing the error;
determining whether a leading error flag is set; and
sending an indication indicative of the record that caused the error during the read ahead operation according to the leading error flag.

9. A method as recited in claim 8, wherein the data storage device is a tape drive.

10. A method as recited in claim 8, comprising receiving a command to set the read range, the command indicating the read range.

11. A method as recited in claim 8, comprising setting a limit on error recovery processing for the read ahead operation.

12. A method as recited in claim 11, wherein the limit includes performing no error recovery procedures during the read ahead operation.

13. An apparatus, comprising:
a magnetic head; and
a controller coupled to the magnetic head, the controller being configured to perform the method of claim 8.

14. A computer program product, the computer program product comprising:
one or more computer readable storage media, and program instructions collectively stored on the one or more computer readable storage media, the program instructions comprising:
program instructions to perform the method of claim 8.

15. A method, comprising:
obtaining, from an index file, a range of records in which a target record is located;
sending a command to set a read range;
sending a read command to read the target record;
receiving the target record; and
receiving an indication indicative of a record within the read range that caused an error during a read ahead operation of records within the read range.

16. A method as recited in claim 15, comprising, in response to receiving the indication, attempting to obtain a copy of at least the record within the read range that caused the error during the read ahead operation from another recording medium.

17. A method as recited in claim 15, comprising, in response to receiving the indication, allowing a data storage device to attempt to recover the record within the read range that caused the error during the read ahead operation.

18. An apparatus, comprising:
a magnetic head; and
a controller coupled to the magnetic head, the controller being configured to perform the method of claim 15.

19. A computer program product, the computer program product comprising:
one or more computer readable storage media, and program instructions collectively stored on the one or more computer readable storage media, the program instructions comprising:
program instructions to perform the method of claim 15.
